(19) United States
(12) Patent Application Publication
(10) Pub. No.: US 2015/0212401 A1
(43) Pub. Date: Jul. 30, 2015

(54) STORAGE BAG ASSEMBLY

(71) Applicant: Coretronic Corporation, Hsin-Chu (TW)

(72) Inventors: WEI-JU CHEN, Hsin-Chu (TW); CHIA-TIEN CHEN, Hsin-Chu (TW)

(21) Appl. No.: 14/485,019

(22) Filed: Sep. 12, 2014

(30) Foreign Application Priority Data
Jan. 28, 2014 (CN) 201410041781.9

(51) Int. Cl. G03B 21/54; B65D 21/08; B65D 85/38; B65D 33/02; B65D 81/02

(52) U.S. Cl. CPC G03B 21/54; B65D 33/02; B65D 81/02; B65D 85/38; B65D 21/08

(57) ABSTRACT

A storage bag assembly includes a connecting element, a bag, and a first plate. The connecting element is used for being connected to a projector. The bag has a first assembling part, wherein the first assembling part is disposed on a top of the bag and the first assembling part of the bag is configured to be assembled with a bottom surface of the connecting element. The bag forms a containing space disposed inside the bag for containing the projector. The first plate is detachably connected to a lateral wall of the bag.

### FIELD OF THE INVENTION

The invention relates to a storage bag assembly, and more particularly to a storage bag assembly for containing or supporting a projector.

### BACKGROUND OF THE INVENTION

Recently, the projector receiving an image signal from an image source to project an image on a screen or a display to enhance the image signal is widely applied in all kinds of video situations such as a presentation, a meeting, a video teaching, a home theater, and so on. Generally, before the user starts to operate the projector, the projector may be disposed on a table or hang the projector on a ceiling

As a result of the technical improvement, the technique of the portable pico projector has increasingly matured such that the needing of the portable pico projector applied in the business presentation is consequentially rising.

In general, a tripod is usually a portable device for supporting the projector. In other words, the tripod is used for fixing with the projector and adjusting the height of the projector and furthering designed to be capable of being carried with the pico projector to accord with the needing of the pico projector. However, the tripod and the pico projector have to be disposed in a bag to be carried together, and thus the bag may be designed to have a larger space for simultaneously containing the tripod and projector such that the volume and the weight of the bag may be heavy. Therefore, the user may feel inconvenient because the bag containing the tripod and the pico projector is too heavy to be carried.

Furthermore, it is an important subject for simultaneously decreasing the weight and the volume of the projector and the supporting device of the projector for portable use. Moreover, how to keep the convenience of the projector in use is also a significant subject.

US publication number 20080230160 discloses a notebook computer bag has an upper cover to adjust the supporting height of the notebook computer. TW patent number M284016 discloses a digital camera for desktop presentation uses a Velcro structure to connect to another connecting structure. TW patent number M431622 discloses a bag has a holder to hold a projector.

### SUMMARY OF THE INVENTION

The invention provides a storage bag assembly for decreasing integral volume and weight of a bag containing a projector assembling device and a projector.

According to an embodiment of the invention, a storage bag assembly includes a connecting element, a bag, and a first plate. The connecting element is used for being connected to a projector. The bag has a first assembling part disposed on a top of the bag for being assembled with a bottom surface of the connecting element. The bag forms a containing space disposed inside the bag for containing the projector. The first plate is detachably connected to a lateral wall of the bag.

According to another embodiment of the invention, the storage bag assembly further includes several second plates, wherein bottoms of the second plates are detachably assembled with a top of the first plate such that the second plates are detachably connected to the lateral wall of the bag.

According to another embodiment of the invention, each of the second plates has at least one first embedded slot for being embedded with the top of the first plate.

According to another embodiment of the invention, the storage bag assembly further includes several third plates, wherein bottoms of the third plates are detachably assembled with tops of the second plates such that the third plates are detachably connected to the lateral wall of the bag.

According to another embodiment of the invention, each of the third plates has at least one second embedded slot for being correspondingly embedded with one of the tops of the second plates.

According to another embodiment of the invention, the bag has an extending part disposed on the lateral wall of the bag for stretching and extending a vertical height of the containing space.

According to another embodiment of the invention, the connecting element has a second assembling part disposed on a bottom surface of the connecting element for being assembled with the first assembling part of the bag.

According to another embodiment of the invention, the first assembling part is a Velcro hook structure and the second assembling part is a Velcro loop structure or the first assembling part is the Velcro loop structure and the second assembling part is the Velcro hook structure.

According to another embodiment of the invention, the first assembling part is a magnetic-attraction element and the second assembling part is a magnetic-induction element or the first assembling part is the magnetic-induction element and the second assembling part is the magnetic-attraction element.

According to another embodiment of the invention, the connecting element includes a disk, a bottom of the disk connected to the second assembling part, a connecting unit, and a cushion. The connecting unit is disposed on the disk for being connected with the projector and the cushion is disposed on a top surface of the disk.

According to another embodiment of the invention, the first assembling part is disposed on an outer surface of the top of the bag.

According to another embodiment of the invention, the first assembling part is disposed on an inner surface of the top of the bag, and the first assembling part is configured to be assembled with the bottom surface of the connecting element when the inner surface of the bag is turned inside out.

The storage bag assembly of the invention may be used not only for containing the projector but also for supporting the projector when the first plate is assembled with the lateral wall of the bag. In addition, because the first plate used for supporting the projector has lighter weight, the storage bag assembly may have a lighter integral weight. Simultaneously, because the space of the bag occupied by the first plate is smaller, the storage bag assembly may have the smaller integral volume.

### BRIEF DESCRIPTION OF THE DRAWINGS

The invention will become more readily apparent to those ordinarily skilled in the art after reviewing the following detailed description and accompanying drawings, in which:

FIG. 1 illustrates a schematic view of a storage bag assembly when a projector is contained in the storage bag assembly according to an embodiment of the invention;

FIG. 2 illustrates a schematic view of the storage bag assembly of FIG. 1 when the projector is supported on the storage bag assembly;

FIG. 3 illustrates a lateral view of the storage bag assembly of FIG. 1 when the projector is supported on the storage bag assembly;

FIG. 4 illustrates an exploded view of a connecting element of the storage bag assembly of FIG. 1;

FIG. 5 illustrates a schematic view of a storage bag assembly when the projector is supported on the storage bag assembly according to another embodiment of the invention;

FIG. 6 illustrates a schematic view of second plates of a storage bag assembly assembled with a first plate of the storage bag assembly according to another embodiment of the invention; and

FIG. 7 illustrates a schematic view of third plates of a storage bag assembly assembled with second plates of the storage bag assembly according to another embodiment of the invention.

### DETAILED DESCRIPTION OF PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

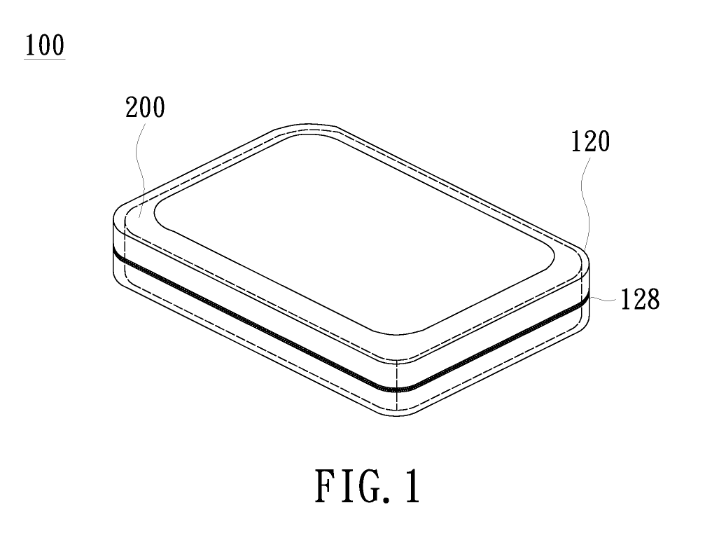

Referring to FIG. 1, FIG. 1 shows a schematic view of a storage bag assembly 100 when a projector 200 is contained in the storage bag assembly 100 according to an embodiment of the invention. As shown in FIG. 1, the storage bag assembly 100 includes a bag 120, wherein a containing space 120a is disposed inside the bag 120 and the projector 200 is contained in the containing space 120a. In this embodiment, the projector 200 may be a pico projector, however, the invention is not limited thereto.

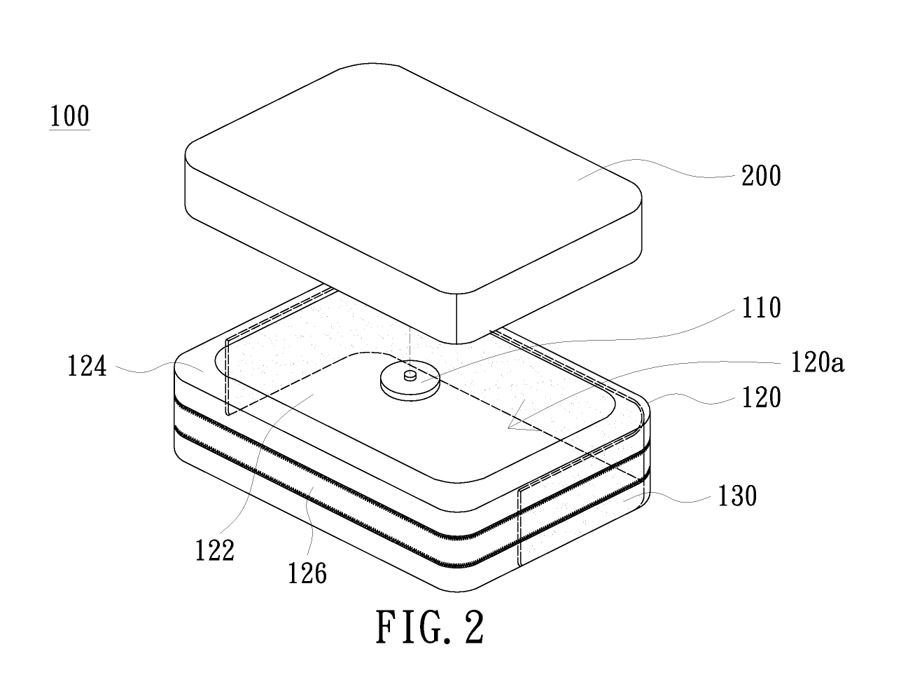

Referring to FIG. 2, FIG. 2 shows a schematic view of the storage bag assembly 100 of FIG. 1 when the projector 200 is supported on the storage bag assembly 100. As shown in FIG. 2, the storage bag assembly 100 includes a connecting element 110, the bag 120, and a first plate 130. It should be understood that the connecting element 110 and the first plate 130 may be simultaneously contained in the containing space 120a of the bag 120 when the projector 200 is disposed in the containing space 200a of bag 200, however, the invention is not limited thereto.

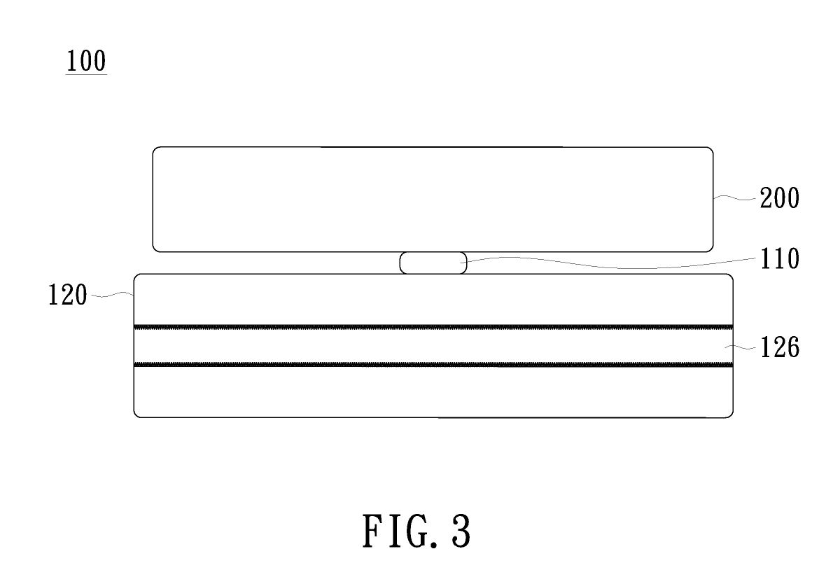

Please refer to FIG. 3, FIG. 3 shows a lateral view of the storage bag assembly 100 of FIG. 1 when the projector 200 is supported on the storage bag assembly 100. As shown in FIG. 2 and FIG. 3, The bag 120 has a first assembling part 122 disposed on a top 124 of the bag 120 and configured to be assembled with a bottom surface of the connecting element 110, wherein the first assembling part 122 may be connected to the projector 200 such that the projector 200 and the connecting element 110 are concurrently disposed on the top 124 of the bag 120 after the projector 200 is assembled with the connecting element 110. In this embodiment, the first assembling part 122 is disposed on an outer surface of the top 124 of the bag 120, however, the first assembling part 122 is disposed on an inner surface of the top 124 of the bag 120 in other embodiments. The first assembling part 122 is exposed from the top 124 of the bag 120 to be assembled with the bottom surface of the connecting element 110 when the inner surface of the bag 120 is turned inside out. It should be understood that the above embodiments are only exemplification of the invention and not limited to implement the invention.

Moreover, the first plate 130 is detachably connected to a lateral wall of the bag 120 for strengthening the supporting force of the lateral wall of the bag 120. When the first plate 130 is connected adjacent to the lateral wall of the bag 120, the first plate 130 and the lateral wall of the bag 120 may corporately support the top 124 of the bag 120. Furthermore, the first plate 130 and the lateral wall of the bag 120 may corporately support the projector 200 to complete the setting step of the projector 200 such that the projector 200 may project the image after the projector 200 is assembled with the connecting element 110 to be disposed on the top 124 of the bag 120. In this embodiment, the first plate 130 is detachably connected to an inner surface of the lateral wall of the bag 120, however, the invention is not limited thereto, the first plate 130 is detachably connected to an outer surface of the lateral wall of the bag 120 in other embodiments.

In this embodiment, the first plate 130 may be a collapsible hard plate such as a hard paper board, an acrylic sheet, and so on. When the projector 200 is contained into the bag 120, the first plate 130 may be corporately contained into the bag 120, however, the invention is not limited thereto.

On the other hand, the bag 120 may have an extending part 126 disposed on the lateral wall of the bag 120. The extending part 126 may be folding inward to be contained into the containing space 120a of the bag 120 when the bag 120 is capable of containing the projector 200. Thus, a size of the containing space 120a containing the extending part 126 may correspond to a size of the projector 200 such that the projector 200 is adaptively contained in the containing space 120a of the bag 120. However, the extending part 126 may expose on the outer surface of the bag 120 in order to stretch and extend a vertical height of the containing space 120a to a predictive height that the projector may project the image. It should be understood that the vertical height of the containing space 120a is equal to a vertical height of the bag 120.

In this embodiment, the bag 120 may have a combining structure 128 and the combining structure 128 may make two opposite ends of the extending part 126 be assembled with each other when the extending part 126 is folding inward to be contained into the containing space 120a of the bag 120. For instance, the combining structure 128 may be a slide-fastener structure, wherein two opposite sprockets of the combining structure 128 are respectively connected to the two opposite ends of the extending part 126. When the extending part 126 is folding inward to be contained into the containing space 120a of the bag 120, the two opposite sprockets are clenched with each other along a direction to zip the combining structure 128. Relatively, if the bag 120 needs to extend the vertical height of the bag 120, the two sprockets of the combining structure 128 may be separated such that the extending part 126 may stretch and extend a vertical height of the bag 120. It should be understood that the above embodiments are only exemplification of the invention and not limited to implement the invention.

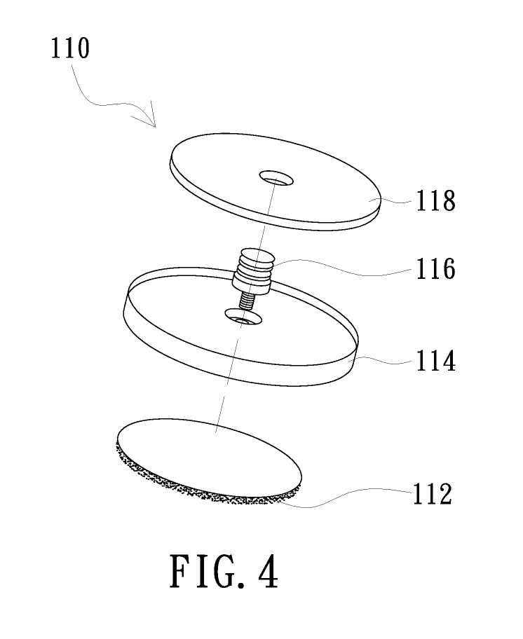

Please refer to FIG. 4, FIG. 4 shows an exploded view of a connecting element 110 of the storage bag assembly 100 of FIG. 1 in order to describe the connecting element 110. As shown in FIG. 4, the connecting element 110 has a second assembling part 112, wherein the second assembling part 112 is disposed on a bottom surface of the connecting element 110 for being assembled with the first assembling part 122 of the bag 120. Furthermore, the connecting element 110 includes a disk 114, a connecting unit 116, and a cushion 118, wherein the second assembling part 112 is disposed on a bottom of the disk 114. In this embodiment, the disk 114 may have a round shape, however, the invention is not limited thereto. On the other hand, the connecting unit 116 is disposed on the disk 114 for connecting to the projector 200. In this embodiment, the connecting unit 116 may be disposed on a axle center of the disk 114, however, the invention is not limited thereto. In this embodiment, the connecting unit 116 has a thread for screwing to a thread hole (no shown) of a bottom of the projector 200 such that the projector 200 may be connected to the connecting unit 116. It should be understood that the combination way of the connecting unit 116 combined with the projector 200 is not limited to the above embodiments. In addition, the cushion 118 is disposed on a top surface of the disk 114 and the bottom surface of the projector 200 is contacted to the cushion 118 such that the projector 200 may be stably assembled with the connecting element 110. In this embodiment, the cushion 118 may be a rubber, however, the invention is not limited thereto. Simultaneously, the shapes of the cushion 118 and the second assembling part 112 are substantially equal to the shape of the disk 114. In other words, the cushion 118 and the second assembling part 112 may be a round shape, however, the invention is not limited thereto.

Furthermore, please referring to FIG. 2 and FIG. 4, in other embodiments, the first assembling part 122 may be a Velcro loop structure and the second assembling part 112 may be a Velcro hook structure such that the first assembling part 122 may detachably assemble with the second assembling part 112. It should be understood that the first assembling part 122 may be a Velcro hook structure and the second assembling part 112 may be a Velcro loop structure. In another embodiment, the first assembling part 122 may be a magnetic-attraction element and the second assembling part 112 may be a magnetic-induction element such that the first assembling part 122 may detachably assemble with the second assembling part 112. It should be understood that the first assembling part 122 may be the magnetic-induction element and the second assembling part 112 may be the magnetic-attraction element. It should be understood that the above embodiments are only exemplification of the invention and not limited to implement the invention.

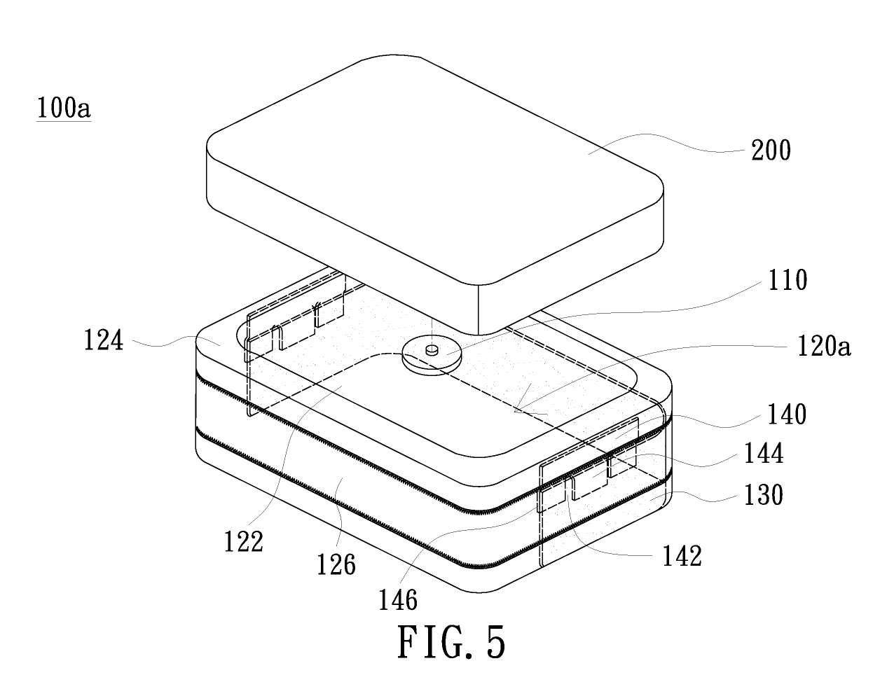

FIG. 5 shows a schematic view of a storage bag assembly 100a when the projector 200 is supported on the storage bag assembly 100a according to another embodiment of the invention. As shown in FIG. 5, the storage bag assembly 100a further includes several second plates 140, wherein bottoms of the second plates 140 are detachably assembled with a top of the first plate 130 such that the second plates 140 assembled with the first plate 130 are detachably connected to the lateral wall of the bag 120 for supporting the top 124 of the bag 120 in order to form the predictive height. Thus, the projector 200 may project the image on the predictive height. In this embodiment, the first plate 130 and the second plates 140 are detachably connected to an inner surface of the lateral wall of the bag 120. In other embodiments, the first plate 130 and the second plates 140 are detachably connected to an outer surface of the lateral wall of the bag 120. In this embodiment, each of the second plates 140 has two first embedded slots 142 detachably embedded with the top of the first plate 130, wherein a central part 144 of each of the second plates 140 disposed between the two embedded slots 142 may be abutted on an outer surface of the first plate 130, and side parts 146 of each of the second plates 140 may be abutted on an inner surface of the first plate 130. The side parts 146 of each of the second plates 140 and the central parts 144 of each of the second plates 140 may flexibly clamp with the first plate 130 such that the second plates 140 may be assembled with the first plate 130, however, the invention is not limited thereto. In other embodiments, the central part 144 of each of the second plates 140 may be abutted on the inner surface of the first plate 130 and the side parts 146 of one of the second plates 140 may be abutted on the outer surface of the first plate 130.

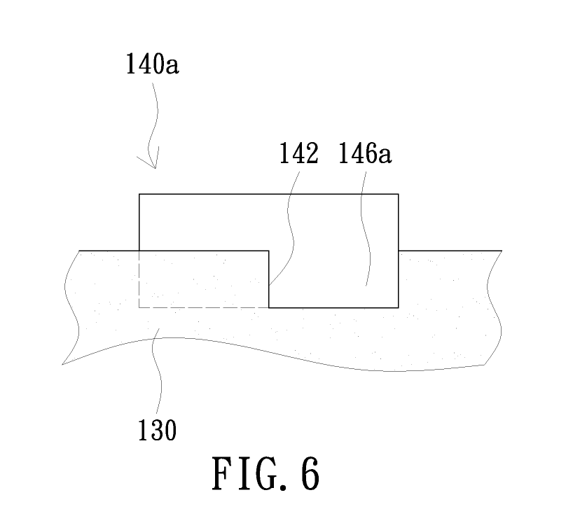

It should be understood that the number of the first embedded slots 142 are not limited to two. FIG. 6 shows a schematic view of second plates 140a assembled with a first plate 130 of the storage bag assembly according to another embodiment of the invention. As shown in FIG. 6, each of the second plates 140 has at least one first embedded slot 142 for being embedded with the top of the first plate 130. Side parts 146a of each of the second plates 140 may be respectively abutted on an inner surface and an outer surface of the first plate 130, wherein the side parts 146a is formed by the first embedded slot 142. It should be understood that the above embodiments are only exemplification of the invention and not limited to implement the invention.

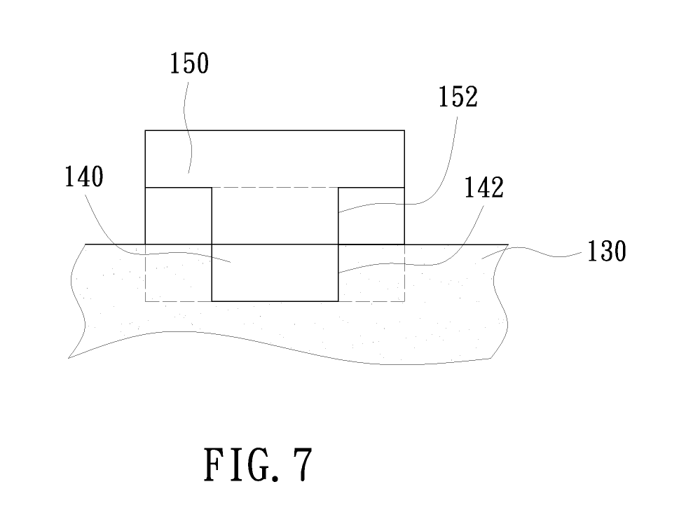

FIG. 7 shows a schematic view of third plates 150 of a storage bag assembly 100 assembled with second plates 140 of the storage bag assembly 100 according to another embodiment of the invention. As shown in FIG. 7, the storage bag assembly 100 further includes several third plates 150, wherein bottoms of the third plates 150 are detachably assembled with tops of the second plates 140 such that the third plates 150 are detachably connected to the lateral wall of the bag 120. Base on assembling with the first plates 130, the second plates 140, and the third plates 150, the height of the bag 120 may be enhanced, in other words, the height requirement of the projector 200 projecting the image may be enhanced. Each of the third plates 150 may have at least one second embedded slot 152 for correspondingly being embedded with the top of one of the second plates 140. However, each of the third plates 150 may have two second embedded slots 152 for being correspondingly embedded with the top of one of the second plates 140, the invention is not limited thereto. In another embodiment, the shape of each of the third plates 150 may be equal to the shape of one of the second plates 140 shown in FIG. 6, the invention is not limited thereto. It should be understood that the number of the third plates 150 corresponds to the number of the second plates 140. In other words, the number of the second plates 140 and the third plates 150 may be selected to adjust the vertical height of the bag 120 when the second plates 140 and the third plates 150 are assembled with the first plates 130 connected to the lateral wall of the bag 120. thus, the required height of the projector 200 projecting the image may be adjusted.

In other embodiments, other plates may be embedded above the third plates 150 to be connected to the lateral wall of the bag 120 and to support the top 124 of the bag 120 in order to enhance the required height of the projector 200 projecting the image. In other words, the vertical height of the bag 120 of the storage bag assembly 100 may be adjusted by assembling of the first plate 130, the second plates 140, the third plates 150 and other plates, thus, the required height of the projector 200 projecting the image may be adjusted. It should be understood that the above embodiments are only exemplification of the invention and not limited to implement the invention.

From the above, the storage bag assembly may be used for containing the projector or supporting the projector when the first plate is assembled with the lateral wall of the bag. Therefore, the first plate has smaller weight for supporting the projector, and the storage bag assembly may also have a smaller integral weight. Simultaneously, because the space occupied by the first plate is smaller, the storage bag assembly may have the smaller integral volume. Furthermore, the second plates and third plates may be selectively assembled with each other to adjust the required height of the projector such that the convenience of using the storage bag assembly may be enhanced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A storage bag assembly comprising:
a connecting element for being connected to a projector;
a bag forming a containing space disposed inside the bag for containing the projector, wherein the bag has a first assembling part disposed on a top of the bag and configured to be assembled with a bottom surface of the connecting element; and
a first plate for being connected to a lateral wall of the bag.

2. The storage bag assembly according to claim 1, further comprising: a plurality of second plates, wherein bottoms of the second plates detachably assembled with a top of the first plate such that the second plates are detachably connected to the lateral wall of the bag.

3. The storage bag assembly according to claim 2, wherein each of the second plates has at least one first embedded slot for being embedded with the top of the first plate.

4. The storage bag assembly according to claim 2 further comprising: a plurality of third plates, wherein bottoms of the third plates detachably assembled with tops of the second plates such that the third plates are detachably connected to the lateral wall of the bag.

5. The storage bag assembly according to claim 4, wherein each of the third plates has at least one second embedded slot for being correspondingly embedded with one of the tops of the second plates.

6. The storage bag assembly according to claim 1, wherein the bag has an extending part disposed on the lateral wall of the bag for stretching and extending a vertical height of the containing space.

7. The storage bag assembly according to claim 1, wherein the connecting element has a second assembling part disposed on a bottom surface of the connecting element for being assembled with the first assembling part of the bag.

8. The storage bag assembly according to claim 7, wherein the first assembling part is a Velcro hook structure and the second assembling part is a Velcro loop structure or the first assembling part is the Velcro loop structure and the second assembling part is the Velcro hook structure.

9. The storage bag assembly according to claim 7, wherein the first assembling part is a magnetic-attraction element and the second assembling part is a magnetic-induction element or the first assembling part is the magnetic-induction element and the second assembling part is the magnetic-attraction element.

10. The storage bag assembly according to claim 7, wherein the connecting element comprises a disk, a bottom of the disk is connected to the second assembling part, a connecting unit disposed on the disk for being connected with the projector, and a cushion disposed on a top surface of the disk.

11. The storage bag assembly according to claim 1, wherein the first assembling part is disposed on an outer surface of the top of the bag.

12. The storage bag assembly according to claim 1, wherein the first assembling part is disposed on an inner surface of the top of the bag, and the first assembling part is configured to be assembled with the bottom surface of the connecting element when the inner surface of the bag is turned inside out.
